(19) United States
(12) Patent Application Publication
(10) Pub. No.: US 2021/0146579 A1
(43) Pub. Date: May 20, 2021

(54) METHOD FOR PRODUCING A HOLLOW PROFILE HAVING VARIABLE CURVATURES AND CROSS-SECTIONS

(71) Applicant: SGL CARBON SE, Wiesbaden (DE)

(72) Inventors: Andreas WOEGINGER, Meitingen (DE); Andreas WUELLNER, Meitingen (DE); Andreas ERBER, Meitingen (DE); Olaf RUEGER, Taufkirchen (DE); Felix FROEHLICH, Taufkirchen (DE); Tobias KNAIER, Taufkirchen (DE)

(73) Assignee: SGL CARBON SE, Wiesbaden (DE)

(21) Appl. No.: 17/254,455

(22) PCT Filed: Jul. 16, 2019
(86) PCT No.: PCT/EP2019/069167

§ 371 Date: Dec. 21, 2020

(30) Foreign Application Priority Data
Jul. 16, 2018 (DE) 10 2018 211 793.4

(51) Int. Cl. B29C 33/52; B29C 53/80; B29C 63/00; B29C 63/24; B29C 70/32; B29D 99/00

(52) U.S. Cl. CPC B29C 33/52; B29C 53/8016; B29C 53/805; B29D 99/0007; B29C 63/24; B29C 70/32; B29C 63/0073

(57) ABSTRACT

A method for producing wound hollow profiles having variable curvatures and cross-sections. In this case, a core having at least one curvature or cross-sectional change is moved in a translatory manner relative to a system having at least a first and a second fibre feed which cause the formation of an axial fibre reinforcement and at least one first wound layer.

The present invention relates to a method for producing wound fibre-reinforced hollow profiles having variable curved portions, cross sections and material thicknesses, and which also have an additional axial fibre reinforcement.

Fibre-reinforced hollow profiles for industrial purposes are traditionally produced by means of braiding methods. In these processes, coils of thread material extend in a circular manner about an axis of a braided core and form a uniform braid consisting of thread material on the braided core, generating thread crossing points, as described in DE 199 25 941 B4, for example. Alternatively, it is possible to produce hollow profiles by means of winding methods, wherein fibre material optionally impregnated with binding agent is wound around a winding core and deposited thereon.

Continuous methods include pultrusion methods, in which fibres impregnated with a resin are drawn through shaped openings that allow the hollow profile to be shaped. WO 2016/066510 describes the continuous production of fibre-reinforced profiles filled with a rigid foam core in a method similar to the pultrusion method. In contrast to the classic pultrusion method, impregnation with the resin is only carried out after the foam core has been wound. The final shaping process then takes place when the resin is cured in a plurality of heated shaping dies.

Braiding methods generally only allow for relatively slow method speeds for producing a hollow profile, since different machine elements of the braiding device have to continually experience acceleration in order to generate fibre crossing points.

In comparison, winding methods are considerably quicker, but have the disadvantage that the hollow profiles produced have low rigidity and strength in their longitudinal direction.

The object of the present invention is therefore to overcome the above-mentioned disadvantages and to provide a fast method for producing hollow profiles that allows for high variability of the hollow profiles produced.

According to the invention, this object is achieved by a method having the features of claim 1.

The method comprises the following method steps:
a. Moving a core having a longitudinal core axis in a translational manner along the longitudinal core axis relative to a system which system comprises at least a first and a second fibre feed, wherein the longitudinal core axis comprises at least one change in direction and/or wherein the core comprises at least one cross-sectional change along the longitudinal core axis;
b. Depositing unidirectional threads from the first fibre feed along the longitudinal core axis in order to form an axial fibre reinforcement; and
c. Winding winding threads from the second fibre feed around the core, which rotates around the core relative thereto, in order to form a first wound layer.

The method according to the invention is quick and productive and allows for high variability in terms of shaping, strength and materials for the hollow profile produced. In addition to an axial fibre reinforcement, this profile can in particular comprise cross-sectional changes and/or curved portions along its longitudinal axis. According to the present method, the hollow profile primarily reproduces the curved portions and/or cross-sectional changes that the core has from the start. In contrast, owing to the process flow in which the profile produced is drawn through a stationary mould, the classic pultrusion method is only suitable for straight tubular hollow profiles. The above-mentioned modification to the method in which the hollow profile is again shaped after a core has been wound, also comprises greater restrictions in terms of curved portions, cross sections and material thicknesses for the hollow profiles produced.

Embodiments and aspects of the invention will be explained in more detail in the following with reference to the drawings, in which:

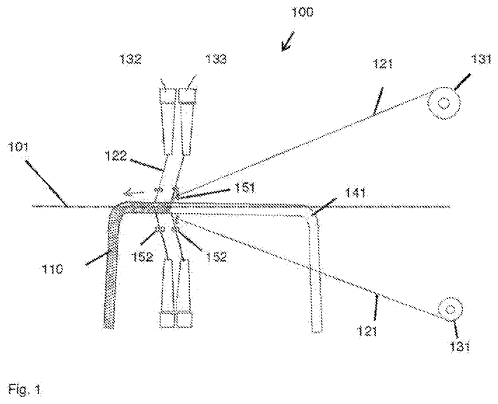

FIG. 1 is a schematic view of an embodiment for carrying out the method according to the invention;

FIG. 2 is a schematic view of an example of a curved hollow profile which can be formed according to the method according to the invention;

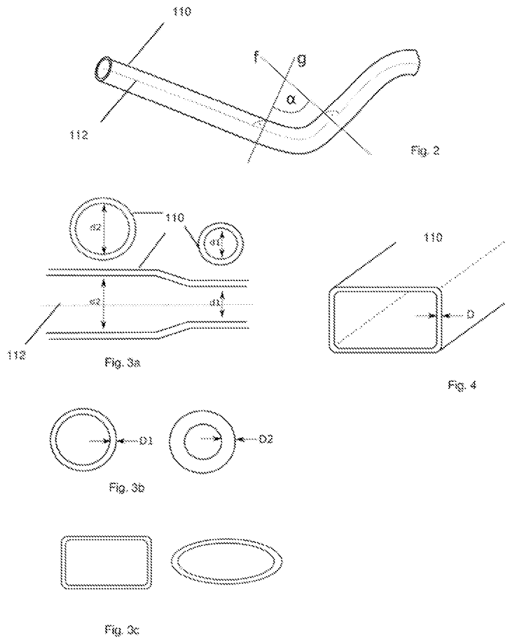

FIGS. 3a to 3c are each schematic views of a cross-sectional change in a hollow profile; and

FIG. 4 is a schematic view of a hollow profile having a material thickness D.

FIG. 2 shows an example of a hollow profile 110 having a variable curvature, which can be formed by the method according to the invention. A curved core or hollow profile is understood to mean a core or hollow profile having a longitudinal axis that has at least one curved portion, i.e. that performs at least one change in direction. Both the core and the hollow profile produced comprise a longitudinal axis that is referred to in the following as the longitudinal core axis or longitudinal profile axis.

Within the context of the present invention, the longitudinal core axis refers to the axis that extends in the particular longitudinal direction through the centroids of the cross-sectional areas of the core. This means in particular that the longitudinal core axis has the longitudinal direction of the core as the preferred direction, but does not have to be a straight line, i.e. the longitudinal core axis can perform changes in direction and the core can therefore have one or more curved portions along the longitudinal axis.

The longitudinal profile axis 112 extends in the longitudinal direction through the centre of the hollow profile and therefore runs through the centroids of the areas, which are surrounded by the hollow profile. Since the hollow profile is usually uniformly formed around the core, the longitudinal profile axis 112 generally corresponds to the longitudinal core axis. The longitudinal profile axis accordingly does not have to be a straight line either, but can comprise changes in direction.

By way of example, a change in direction in the longitudinal profile axis 112 is described in FIG. 2. The longitudinal profile axis 112 comprises a first curved portion which rotates by approximately 50°, which can be described by an angle of curvature α. In this case, the angle of curvature α can be defined as the maximum angle that is formed by two orthogonals f and g of the longitudinal profile axis 112, wherein orthogonal f lies in front of the first curved portion and orthogonal g lies after the first curved portion on the longitudinal axis. The smaller the angle of curvature a is, the smaller the first curved portion of the longitudinal axis is, wherein a straight hollow profile does not comprise an angle of curvature within the context of the present invention. The method according to the invention also makes it possible to produce straight hollow profiles or hollow profiles having small angles of curvature of less than 10°. The method according to the invention is, however, characterised in particular in that it also makes it possible to produce very curved hollow profiles, which comprise one or more angles of curvature of more than 10°. By means of the method according to the invention, the angle of curvature α can also be above 30°. As shown in FIG. 2, the method according to the invention is also suitable for angles of curvature above 45°, wherein the method according to the invention also allows for hollow profiles having angles of curvature of above 90°. In particular, the method according to the invention also allows for the production of even more greatly curved hollow profiles, such as U-tubes, in which the angle of curvature corresponds to 180°. Helical hollow profiles, the angle of curvature of which is greater than 360°, are also possible in theory.

If the cross section differs in two positions on the longitudinal profile axis or longitudinal core axis, within the context of the present invention there is a change in the cross section. The cross-sectional change comprises both the change in the cross-sectional shape, for example from a square to a rectangular or round cross section, as shown in FIG. 3c, and the change in the diameter or surface area in this case. FIG. 3a shows an example of a cross-sectional change within the context of the present invention as a result of the change in the diameter of a hollow profile 110 from d2 to d1, wherein d2>d1. In FIG. 3b, a cross-sectional change is shown by a change in the surface area of the cross-sectional area of the hollow profile caused by an increase in the wall thickness D1 to the wall thickness D2 of the hollow profile. Accordingly, the hollow profile not only reflects the cross-sectional changes to the core, but can also comprise additional cross-sectional changes, for example as a result of local thicker portions.

The principal structure of a system 100 for carrying out a method for producing hollow profiles which can also comprise variable curved portions and cross sections in addition to an axial fibre reinforcement, is shown in FIG. 1. The image shows a first fibre feed 131 comprising unidirectional threads 121, which are deposited on a core 141, and a second fibre feed 132 comprising winding threads 122 which are wound around the core 141. In the present method, the core 141 is not subsequently shaped, but already comprises curved portions and/or cross-sectional changes which are reproduced from the resultant hollow profile 110, before the unidirectional and winding threads are deposited. In an advantageous embodiment, the first fibre feed 131 comprises guide eyelets 151 for accurately positioning the unidirectional threads 121 on the core 141. The guide eyelets 151 are preferably directly applied to the core before the unidirectional threads 121 are deposited and can be small guide eyelets, for example. Additional guide eyelets 152 can optionally also be applied to the core in order to accurately position the winding threads before they are deposited. Rings having integrated guide eyelets are suitable for this, for example. In an advantageous embodiment, the system 100 also comprises a third fibre feed 133 comprising winding threads, and therefore a triaxial fibre structure can be formed. The first, second and third fibre feeds preferably comprise fibre tensioning units for adjusting a fibre tension and each comprise at least one fibre coil.

The individual method steps of the method according to the invention take place substantially simultaneously. During the continuous forward movement of the core 141 along the longitudinal core axis through the system 100, both the unidirectional threads 121 from the first fibre feed 131 and the winding threads 122 from the second fibre feed 132 are deposited on the core 141. The system 100 comprises a system axis 101, along which the unidirectional threads 121 are deposited and about which the second fibre feed 132 rotates, wherein the core is guided through the system such that the longitudinal core axis largely coincides with the system axis 101 at the location of the second fibre feed 132. By depositing the unidirectional threads 121 of the stationary first fibre feed 131 along the system axis 101, in this case the axial fibre reinforcement is achieved, while winding threads 122 are simultaneously wound around the core by means of the second fibre feed 132 that rotates about the system axis 101, and therefore a first wound layer is applied to the core. The axial fibre reinforcement and the first wound layer are therefore applied to the entire core in one run. The hollow profile 110 produced therefore comprises an axial fibre reinforcement and at least one first wound layer, it being advantageous for the first wound layer to be arranged on top of the axial fibre reinforcement in order to fix it.

In an advantageous design, the third fibre feed 133 can be used to form a second wound layer. For this purpose, the third fibre feed 133 rotates similarly to the second fibre feed 132 about the system axis 101 and about the core 141, relative to the core, and winds additional winding threads around the core 141. In an advantageous embodiment, the second and the third fibre feeds rotate in opposing directions about the core 141 and therefore allow for the formation of a compensated composite angle, for example, in which the winding angles of the first and second wound layer only differ with regard to the sign, for example ±30°. In this case, the winding angle describes the angle formed between a winding thread and the longitudinal profile axis 112 or longitudinal core axis, and is determined by the translational movement of the core along the longitudinal core axis relative to the system, which will be discussed again below. In another advantageous embodiment, the second and third fibre feed 132 and 133 rotate at different rotational speeds in the same direction or opposing directions, preferably in opposing directions, and therefore a wound composite is made possible in which the winding angles of the first and second wound layer also differ in terms of the size of the winding angle in addition to the sign.

The system 100 in the method according to the invention can theoretically be guided around the core 141 as said core remains stationary. According to an advantageous embodiment, however, the core 141 is guided along a track through the system 100, wherein the shape of the track corresponds to that of the longitudinal core axis. In this case, the track lies freely in space and is therefore not coupled to an assembly line, rails or the like. Therefore, any changes in direction in the longitudinal core axis can also be implemented for the translational movement of the core, which can be moved upwards, downwards, left and right as desired, while the unidirectional threads 121 are deposited thereon and the second and/or third fibre feed wind winding threads around the core. in this case, the core 141 is guided through the system such that the longitudinal core axis largely coincides with the system axis 101 at the location of the second and/or third fibre feed. Therefore, a curved core can also be uniformly covered with fibre material and wound around.

In this case, the second and third fibre feed preferably carry out a purely rotational movement about the system axis. The purely rotational movement of the machine elements leads to a fast profile production process, in which no thread crossing points are generated.

According to an advantageous embodiment, the translational movement of the core 141 is carried out by at least one arm, preferably at least one industrial robot (according to VDI Guidelines 2860), wherein the at least one arm pulls and/or pushes the core through the system. According to one embodiment, the core is held at a rear end by a first arm and guided, in particular pushed, through the system by a front end thereof. As soon as the unidirectional threads 121 of the first fibre feed 131 and the winding threads 122 of the second 132 and the optional third fibre feed 133 cover at least part of the front end of the core 141, a second arm can hold the core 141, which has been wound around in part, at this part and guide it, in particular pull it, further through the system 100, wherein the first arm can re-release the core 141 at the rear end. The switch from the first to the second arm preferably takes place in a continuous transition. The second arm can now still guide the entire rear end of the core 141 through the system such that the core is completely surrounded by the axial fibre reinforcement consisting of unidirectional threads 121 and a second and optionally third wound layer in the end.

In particular, the winding angle at which the winding threads are applied to the core 141 is determined by the translational speed at which the translational movement of the core 141 is carried out. The winding angle is also determined by the different rotational speeds of the fibre supplies 132 and 133. In both cases, the winding angle can be between 0° and 90°, wherein it can in practice be between 9° and 90°, for example. The winding angle preferably lies between 10° and 89°, particularly preferably between 15° and 85°, more particularly preferably between 20° and 80°. The winding angle is generally smaller the faster the translational movement is performed. A slow translational speed leads to a winding angle near to 90°. The winding angles stated above can differ in terms of the sign+/−.

A reduction in the translational speed, in particular up to the core 141 stopping, can also be used to wind the winding threads 122 around a portion of the core multiple times and therefore to achieve a local increase in the material thickness D, i.e. for example an enhancement of the wall thickness D1 to the wall thickness D2, as shown in FIG. 3b.

The winding angle that is between the particular winding threads and the longitudinal core axis can also differ locally when the core is guided through the system 100 at different translational speeds. In one embodiment of the present invention, the translational movement of the core 141 during method steps a to c firstly takes place at a first translational speed and subsequently at a second translational speed that is different from the first translational speed, wherein winding the winding threads from the second fibre feed 132 around the core 141 at the first translational speed leads to the formation of the first wound layer that has a first winding angle and/or a first layer thickness and, at the second translational speed, leads to the formation of the first wound layer that has a second winding angle and/or a second layer thickness, wherein the second winding angle and the second layer thickness differ from the first winding angle and the first layer thickness, respectively. If the third fibre feed 133 is provided, at the first translational speed the second wound layer is also formed having a third winding angle and/or a third layer thickness, and, at the second translational speed, the second wound layer is formed having a fourth winding angle and/or a fourth layer thickness, wherein the fourth winding angle and the fourth layer thickness differ from the third winding angle and the third layer thickness. In an advantageous embodiment, the third and fourth winding angles correspond to the first and second winding angles, respectively, with opposite signs.

In an advantageous embodiment, the first, second and third fibre supplies are formed such that the first and second wound layers are arranged on top of the axial fibre reinforcement. Additional fibre supplies for forming additional wound layers are also possible.

The unidirectional threads from the first fibre feed and the winding threads can be made of the same material. In another advantageous embodiment, the unidirectional threads from the first fibre feed can comprise a different material to the winding threads. In addition to fibres, preferably continuous fibres, rovings, slivers, impregnated fibres and tapes, which can be impregnated with a thermoplastic or thermoset, can be used as both unidirectional threads and winding threads of the second and third fibre feed. The unidirectional and winding threads are preferably selected from the group consisting of carbon fibres, ceramic fibres, glass fibres, aramid fibres, basalt fibres, polymer fibres and mixtures of two or more of the above-mentioned materials.

The core of the method according to the invention can be a foam core, fusible core, inflatable or expandable core, blown core made of plastics material, residual core or rinsable core.

By means of the various possible variations, in particular for the wound layers (inter alia material, layer thickness, winding angle, number of layers), the hollow profile 110 produced can be adapted to a plurality of different stresses and requirements. The method therefore allows for the production of crossmembers for coaches, roof girders for cars and side members and crossmembers in other vehicle structures, for example. Floor supports for aircrafts and roof racks, roof rails and railing can also be produced by means of the method according to the invention.

1-11. (canceled)

12. A method for producing a hollow profile having a longitudinal profile axis, wherein the hollow profile comprises at least one of at least one cross-sectional change and at least one curved portion, said method comprising:
a. moving a core having a longitudinal core axis in a translational manner along the longitudinal core axis relative to a system, which system includes at least a first and a second fibre feed, wherein the longitudinal core axis includes at least one change in direction and/or wherein the core includes at least one cross-sectional change along the longitudinal core axis;
b. depositing unidirectional threads from the first fibre feed along the longitudinal core axis in order to form an axial fibre reinforcement; and
c. winding threads from the second fibre feed around the core, which rotates around the core relative thereto, in order to form a first wound layer.

13. The method according to claim 12, wherein the translational movement of the core during method steps (a) to (c) firstly takes place at a first translational speed and subsequently at a second translational speed that is different from the first translational speed, wherein winding the winding threads from the second fibre feed around the core at the first translational speed leads to the formation of the first wound layer that has a first winding angle and/or a first layer thickness, and, at the second translational speed, leads to the formation of the first wound layer that has a second winding angle and/or a second layer thickness, wherein the second winding angle and the second layer thickness differ from the first winding angle and the first layer thickness, respectively.

14. The method according to claim 12, wherein the system includes a third fibre feed, wherein the third fibre feed rotates about the core relative thereto, wherein the second and third fibre feed rotate in opposing directions and wherein the third fibre feed forms a second wound layer.

15. The method according to claim 12, wherein the core is wound such that the first and/or second wound layer is and/or are formed having different material thicknesses D along the longitudinal profile axis.

16. The method according to any claim 12, wherein the translational movement of the core is implemented by at least one arm, preferably at least one industrial robot, wherein the at least one arm pulls and/or pushes the core through the system.

17. The method according to claim 12, wherein the system includes a system axis and wherein the second and third fibre feeds perform a purely rotational movement about the system axis.

18. The method according to claim 14, wherein the first and second wound layer are arranged on top of the axial fibre reinforcement.

19. The method according to claim 13, wherein the first winding angle and/or the second winding angle is/are more than 9° and less than 90°.

20. The method according to claim 17, wherein the unidirectional threads comprise the same material as, or a different material to, the winding threads from the second and/or third fibre feed.

21. The method according to claim 12, wherein the unidirectional threads and winding threads each consist of fibres, preferably continuous fibres, bound rovings, silvers, impregnated fibres and/or impregnated tapes and/or comprise carbon fibres, glass fibres, aramid fibres, basalt fibres and/or thermoplastic fibres.

22. The method according to claim 12, wherein the core is a foam core, fusible core, inflatable or expandable core, blown core made of plastics material, residual core or rinsable core.

23. The method according to claim 13, wherein the system includes a third fibre feed, wherein the third fibre feed rotates about the core relative thereto, wherein the second and third fibre feed rotate in opposing directions and wherein the third fibre feed forms a second wound layer.

24. The method according to claim 13, wherein the core is wound such that the first and/or second wound layer is and/or are formed having different material thicknesses D along the longitudinal profile axis.

25. The method according to claim 14, wherein the core is wound such that the first and/or second wound layer is and/or are formed having different material thicknesses D along the longitudinal profile axis.

26. The method according to any claim 13, wherein the translational movement of the core is implemented by at least one arm, preferably at least one industrial robot, wherein the at least one arm pulls and/or pushes the core through the system.

27. The method according to any claim 14, wherein the translational movement of the core is implemented by at least one arm, preferably at least one industrial robot, wherein the at least one arm pulls and/or pushes the core through the system.

28. The method according to any claim 15, wherein the translational movement of the core is implemented by at least one arm, preferably at least one industrial robot, wherein the at least one arm pulls and/or pushes the core through the system.

29. The method according to claim 13, wherein the system includes a system axis and wherein the second and third fibre feeds perform a purely rotational movement about the system axis.

30. The method according to claim 14, wherein the system includes a system axis and wherein the second and third fibre feeds perform a purely rotational movement about the system axis.

31. The method according to claim 15, wherein the system includes a system axis and wherein the second and third fibre feeds perform a purely rotational movement about the system axis.
